(19) United States
(12) Patent Application Publication
(10) Pub. No.: US 2008/0133425 A1
(43) Pub. Date: Jun. 5, 2008

(54) METHOD FOR ROAD USE CREDIT TRACKING AND EXCHANGE

(76) Inventor: Bernard Grush, Toronto (CA)

Correspondence Address: PATTERSON & SHERIDAN, L.L.P., 3040 POST OAK BOULEVARD, SUITE 1500, HOUSTON, TX, 77056, US

(21) Appl. No.: 11/951,182

(22) Filed: Dec. 5, 2007

Related U.S. Application Data
(60) Provisional application No. 60/872,772, filed on Dec. 5, 2006.

(51) Int. Cl. G06Q 30/00; G06F 17/00; G06Q 40/00

(52) U.S. Cl. 705/80; 705/10; 705/37

(57) ABSTRACT

The invention provides a method of administering a road use credit system. The method allows motorists to buy and sell road use credits. The road-use credits are redeemable for road use in a chargeable area. Motorists may be tracked by satellite using an on-board device to determine and calculate chargeable road use. A road use credit exchange is also provided.

### CROSS-REFERENCE TO RELATED APPLICATIONS

This application claims benefit of U.S. provisional patent application Ser. No. 60/872,772, filed Dec. 5, 2006, which is herein incorporated by reference.

### FIELD OF THE INVENTION

This invention relates to methods for road use credit tracking and exchanges for road use credits.

### BACKGROUND OF THE INVENTION

Automotive congestion, whether of roads, streets, highways or parking spaces, is due to excessive demand for these facilities, and causes harm to the commercial and personal productivity of the businesses and people living in the area near and surrounding congested roads and areas. Automotive congestion also raises the levels of noxious automotive emissions that have known air-quality and related health effects and either concentrate in that local area or may spread more widely. Furthermore, automotive congestion is known to raise the risk of personal injury, death, or property damage due to crashes for those vehicles that are moving on congested facilities.

The ability of fuel taxes to financially support road building, operation and maintenance is waning as vehicles become more fuel efficient or use alternate fuels. Moreover, fuel taxation does not distinguish between congested and uncongested roads and times, hence offering road authorities no pricing signal that could be used to control congestion. Effective pricing signals tell motorists about the total costs of their journey including heretofore externalized costs, such as that it is more costly to drive in congested areas or at congested times.

For these several reasons, governments and road authorities are studying and preparing for the impending change to a reduction in open (free) access to roads and an increase in more comprehensive road and parking pricing programs.

Since the mid 1990's, it has been increasingly expected that many jurisdictions will begin engaging in large area road tolling and parking tolling, whether for purposes of controlling automotive congestion, automotive emissions and/or to raise revenue.

At the current time, there are several social issues with such programs, two of which are: 1) the acceptability a new toll or tax on a critical resource (mobility via private automobile, or commercial vehicle or other form of vehicle) and 2) a potential and perceived unfairness that some motorists who have poor access to public transit or may otherwise have little choice but to use a private vehicle may be especially disadvantaged when subjected to such tolls.

This invention is intended to allow governments, transportation authorities, or road authorities (“road authorities”), or any other operator of a transportation network wherein road use charging may be used as a toll for access, to grant road use (access) units (such as time-and-place sensitive mileage credits) to participants and to allow those participants to sell or buy those units from other participants (privately, or in a structured auction marketplace, or in a commodity-type exchange).

### SUMMARY OF THE INVENTION

According to a first aspect of the invention, a method of administering a road use credit system is provided. An administrator (which may be a government, transportation authority, or a private or quasi-private entity contracted to administer road use charging in a jurisdiction) enrolls a plurality of motorists in the road use credit system, and establishes an account for each motorist with a pre-allocated number of road use credits. (The “pre-allocation” of credits may be by a free grant, or the credits may be from prior purchase by the motorists.) Data of the road use of each motorist is received and a pre-determined amount of road use credits is deducted from the motorist's account based on the motorist's road use data. An interface is also provided by which the motorists can purchase additional road use credits. The additional road use credits are added to a motorist's account when purchased. An interface is also provided by which the motorists can communicate with other motorists to negotiate purchase, sale and transfer transactions of their road use credits. The administrator adjusts the balance of road use credits in each of the motorists' accounts at the completion of each said transaction. The interfaces (which may be Internet-based) can be in the same interface program or separate programs.

The credits may be serialized for enabling auditing the transactions and deductions for road use.

Preferably, the road use data is gathered from satellite-tracked on-board units located in cars used by the motorists, which data is determined as the vehicles travel in a monitored area. The road use credits may be deducted based on a distance traveled in the monitored area, and may be further determined according to the time of day. Alternatively, the road use credits may be deducted based on a time spent travelling in the monitored area, or some other basis may be used.

The road use credits may be notionally tracked as distance units (e.g. by “miles” or “kilometers”), as units of a currency (e.g. by “dollars”), or by some other notional unit.

Preferably, additional road use credits are granted to at least one motorist by the administrator based on a criteria, or as part of a lottery.

The purchase price of road use credits may be fixed, or negotiable, or a combination of fixed and negotiable.

The road use credits may be deducted based on path of travel on a chargeable road. The rate of deduction may be a function of the traffic congestion on the chargeable road.

According to a second aspect of the invention, a method is provided for enabling a transaction in road use credits between a first motorist and a second motorist. An offer proposal is received from a first motorist having a number of road use credits. A purchase proposal is received from a second motorist wishing to acquire the number of road use credits held by the first motorist. A payment from the second motorist is verified as received by the first motorist for the purchase of the road use credits (or the first motorist may authorize that the road use credits be transferred without payment—e.g. as a gift). Upon payment (or authorization), the road use credits are deducted from an account of the first motorist and added to an account of the second motorist.

Various configurations of the purchase and sale mechanism are possible. The exchange of offer and acceptance may be carried out using an interface accessible to both the first and second motorists (such as an Internet-based interface, as set out above). The system may also be structured so that the first motorist may entertain various purchase proposals from a plurality of second motorists and then select one of the proposals (such as in an auction format).

The credits may be serialized for enabling auditing the transactions.

The method may further include verifying the account status of either or both of the first motorist and the second motorist. The transaction may be refused by the administrator if either of the accounts is suspended.

The method may be structured so that the first motorist and the second motorist are anonymous or pseudonymous to each other during the transaction.

According to a third aspect of the invention, a method is provided for enabling exchange transactions in road use credits among a plurality of motorists having accounts of road use credits. A commodities exchange is provided for the motorists to trade road use credits between and among themselves. A first subset of motorists have credits debited from their accounts in exchange for payments issued by the exchange, and a second subset of motorists have credits credited to their accounts in exchange for payments paid to the exchange by the second subset of motorists.

The exchange may be structured such that the price of road use credits is fixed (or a minimum price is fixed), or the fair market value of the credits may be determined by the market forces of supply and demand as the exchange is operated.

### BRIEF DESCRIPTION OF THE FIGURES

FIG. 1 is a flow diagram of processes whereby road use (access) credits can be acquired or sold by users.

FIG. 2 is a schematic diagram of a vehicle tracked by a satellite to obtain road use data.

FIG. 3 is a schematic diagram of an uploading process whereby road use data is supplied by an on-board unit of a vehicle to a central data facility.

FIG. 4 is a flow diagram of processes whereby road use credits are negotiated within a user account and deducted according to the use of the vehicle in chargeable locations.

FIG. 5 is a sample bill for a motorist showing a beginning credit balance and deductions as road use charges are incurred.

### DETAILED DESCRIPTION

The invention allows an arbitrary pool of vehicle registrants and operators, and optionally, local residents, (collectively, “motorists”) to buy, sell or trade road use credits (e.g. mileage credits) which are redeemable for road use (including roads, bridges, tunnels, or parking spaces) in chargeable locations (i.e. wherever travel in that location is predicated on paying a toll, tax or fee).

Although various physical embodiments are possible, the following functional components are preferred for accurate execution of the method according to the present invention:
1. A secure hardware device, mounted in or on the vehicle (an “on-board device”), capable of measuring a time-marked and location-marked journey distance. This journey should be marked second-by-second or minute-by-minute precision—i.e., often enough to permit correct assessment of pre-determined, time-related charges. It should also, but not critically, be location-marked meter-by-meter or at any other distance precision or in small digitized increments that permit the correct assessment of pre-determined, location-related charges.
2. A reliable and accurate positioning system/technology. The most appropriate method for the metering described in point 1 is to use Global Navigation Satellite System (GNSS) signals to calculate a time-marked, position-marked, distance log (“travel-log”) for metering road use moment-by-moment, dependent on time and place. Examples of this type of system are described in: U.S. Pat. No. 7,215,255; PCT/CA2007/000456 (pending); and U.S. 60/987,131 (pending), all of which are incorporated herein by reference. However, it will be appreciated that various methods and technologies may be used effectively to obtain measurable time, position and distance data, whether or not embodied in a travel-log. Indeed, this invention would still apply, in a diminished manner, even if only the odometer used.
3. A central computing facility (or network of such facilities) programmed to calculate bills and road use credit balances for the participants (motorists). This facility may also administer interfaces for purchase and sale of credits and/or an exchange (or this may be run as a separate facility).
4. Transmission facilities to move the information gathered by the on-board device to the datacenter. This may be done using any of a plurality of wireless or manual techniques that are secure and private. Wireless examples include any, or a combination of, GPRS, GSM, DSRC or any other method, including any not yet invented that can be shown to be reliable for the purpose of moving data from the vehicle to the central computing facility.
5. An interface to allow participants to know their credit balance, to offer them for sale, to offer to purchase more. This may include a computerized credit management system that could be accessed in any of the ways corporate stocks may be sold or purchased today (internet, automated phone system, phone with human agent at other end, bank teller, agent in person) and may be centralized or distributed via a network of local merchants in the same manner as transit tickets or lottery tickets are currently distributed in many cities.

A city such as New York or London, or a state such as Oregon, or a country such as The Netherlands may wish to charge motorists for road use in some or all of its roadway facilities to manage congestion, and/or emissions, and/or to complement or replace fuel taxes. To ease the economic impact of such a new tax, to promote social fairness, to subsidize less advantaged motorists and transit users, and to add incentives to select alternative transportation modes, the road authority could provide participants a grant of free or highly discounted access units (road use credits). Said units would be used to access miles, kilometers, minutes or any other unit of roadway consumption of priced roadway as needed. The reason these are measured in access units is because distance units will have variable costs depending on location or time of day that distance is consumed.

For example, a city that wished to charge a fee of X dollars, euros, yuan, yen, or other monetary unit (“dollars”) per access unit might grant to each participant 1000 free access units and another 2000 units at 0.5× dollars, with additional units available at the stated X dollars. The cardinality of those additional units may be limited or unlimited. If that same city permitted a credit exchange amongst those participants, then any of those participants could sell those credits at a value approaching 3000 times X and any other participant could purchase them. Said selling and buying is mediated via a computerized mechanism that manages the pool of such credits in a manner that preserves the privacy of the participants from each other.

Some of the expected effects of such a credit exchange program would be:
1. Disadvantaged participants would be granted some immediate relief, especially as they may need time to adapt in some way to the new tolls. This would blunt social criticism regarding unfairness or loss of entitlement and reduce the expected political liability of supporting road-pricing programs.
2. Some participants who could find alternative travel modes (transit, bike, carpool, altered travel times, walk, telework, move closer, etc) would sell these credits to finance their alternate modal use. In a percentage of these cases, participants might decide not to drive their vehicle on those specific roads, at priced times; other participants might decide to sell their vehicle altogether. (For this latter effect to be sustained, the road authority might distribute credits to all legal residents of driving age within the appropriate jurisdiction and surrounds. The cost of such a distribution program could be absorbed by the road-pricing scheme.)
3. Providing access credits to all registered residents can provide an additional element of fairness. This allows a family with children or aging or disabled relatives who must be shuttled to have access to additional credits. This also allows people who do not drive to has a bike or transit subsidization. This has the effect of encouraging more people to consider alternate modalities. It helps diminish the misunderstanding that “road-pricing hurts the poor”. It prices people “onto transit” rather than “off the road”.
4. If said road authority put a ceiling on the number of units available to the entire pool of participants, that market would exactly measure the value of access for that population of participants at any particular time. This would tell said road authority what it needs to know regarding setting of prices—informing the “price-map”for a particular program, road network or geographic area. This in turn would further elasticize the value of the access units making controlled price fluctuations possible. If correctly controlled, these would provide the ability to maximize infrastructure load without generating congestion. (This invention works whether the road authority grants some discounted units or puts a ceiling on the entire number of units available.)
5. Such a credit exchange market would compound the market effect of the intended “pricing signals”.

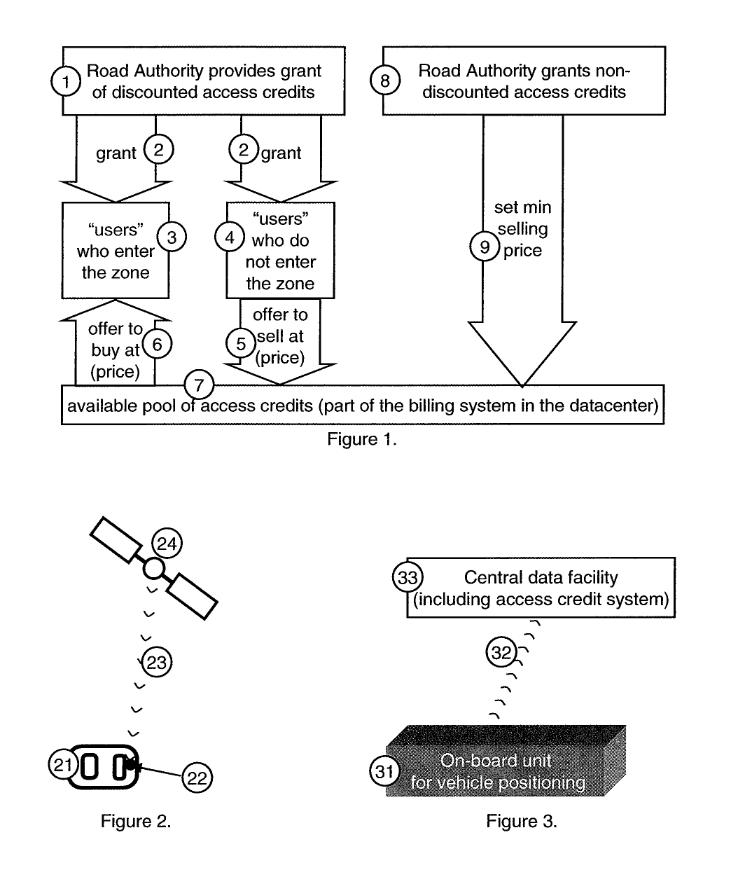

Referring to FIG. 1, the appropriate road authority(ies) 1 provides a grant 2 of unpriced or discounted access credits to all participants appropriate to the scheme, program or network under consideration. Since this grant may include non-motorists, so that all residents that require mobility are able to engage in the market, some grant recipients will use the credits 3 while others will not 4. The latter group 4 will be able to sell their credits to those in the former group 3 via a buy-sell mechanism 5,6 brokered by any number of interfaces (web, kiosk, phone, etc).

In order to sell, a seller sets an asking price and a unit count 5. A deal may be arrived at privately with a buyer using the interface (not shown). Alternatively, the deal may be arranged via an auction. The system may set a lot number for the seller's asking price and unit count. In order to buy, a buyer may bid on the lot, setting an offering price and a unit count 6 (the system setting a request number). The system may then proceed to match the buy-sell prices on a first-come-first served basis, or the seller may select a best offer among the seller bids.

As the pool of available credits 7 is exhausted, the road authority may grant non-discounted access credits 8 on a schedule and at prices that are suited to its mandate of raising revenue and managing congestion. Said authority may grant an unlimited number of credits at a constant price 9, in much the same way that most roads are priced now, it may offer a limited or unlimited number of credits at gradually increasing prices reflecting scarcity, or it may offer an unlimited number of credits at slowly fluctuating prices reflecting congestion trends. In other words, by regulation, the market may be controlled, it may be used to control (congestion), and it may even allow speculation. All such economic mechanisms may be organized by the regulations that mandate the said road authority. This invention enables a variety of market policies. The road authority may directly manage the buy-sell, auction or exchange facilities, or these may be administered by a separate administrator.

Referring to FIG. 2, in order to consume these access credits, whether granted or purchased, a participant will require an appropriately registered vehicle 21 that is equipped with a metering device 22 that accurately meters the distance of journeys. For maximum economic efficiency, said device should measure the location and time of road-usage. This, in turn, is best achieved by reading positioning signals 23 from a system of navigation satellites 24, such as, but not constrained to, the Global Positioning System (GPS), Galileo, GLONASS or COMPASS. Alternatively, positioning systems based on cellular or TV signals or other triangulation system may be used.

Referring to FIG. 3, in order that this distance, and preferably location and time data, is available to generate a road-use bill (see, for example, FIG. 5) and to debit the credits granted or purchased by the participants, an on-board unit 31 related to or part of the metering device 22 (FIG. 2) stores, compresses, encrypts and transmits 32 this data to a central facility 33 that includes the access credit system managing the pool of access credits 7 (FIG. 1).

As an alternative embodiment, it is possible to replace transmission 32 and central billing calculation 33 by deploying additional processing within the vehicle so that billing calculations for road use may be made on-board and the recording and debiting of access credits may be handled through more manual means, such as with smart cards or similar controlled memory device. On board billing and on-board credit management can be applied to this process as a means to enhance the perception and sometimes the quality of privacy.

This invention of a road-use credit exchange is claimed whether the road-use billing system is centralized or distributed.

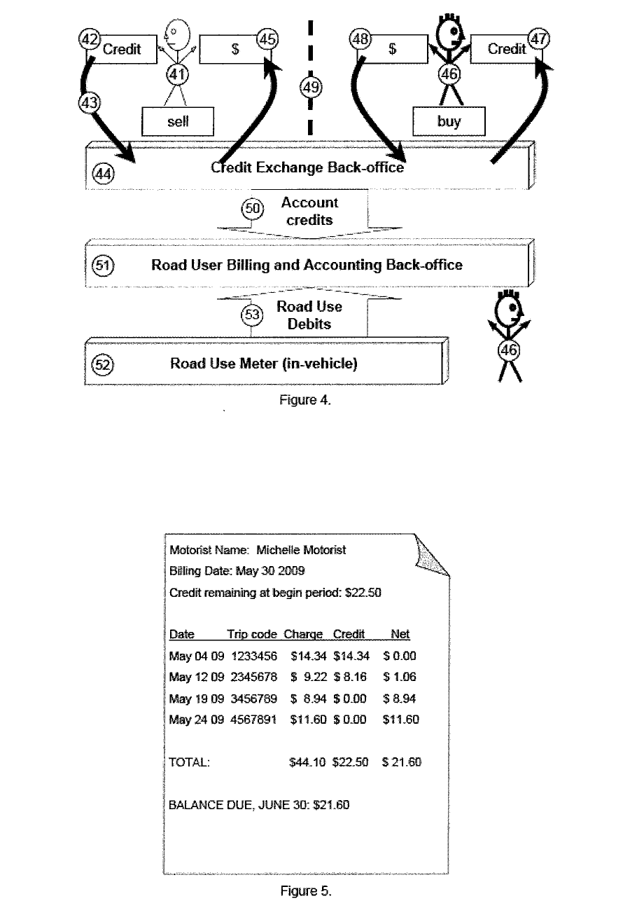

Turning to FIG. 4, a qualified resident 41 is granted a credit 42 which he may sell 43 via a credit exchange 44 in exchange for a cash equivalent 45. A motorist 46 may purchase road use credits 47 with a cash equivalent 48 via the same exchange 44. The buyer and seller may or may not know each other 49. Account credits so sold and purchased are used to credit 50 the motorist's 46 road-use credit account as managed in a road user billing and accounting back-office 51. The motorist 46 has an in-car road-use meter 52 (an on-board device), that meters and forwards road use data (debits 53) to the road user billing and accounting back-office 51. The back-office deducts appropriate credits from the motorist's account.

Turning to FIG. 5, an example is shown of a bill that a motorist would receive listing outstanding credits, new debits and a new balance.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims. In particular, this invention can be applied in part or its entirety in any circumstance wherein the position of a person or asset will be recorded and audited, publicly, privately, or anonymously, in real time or with an arbitrary time delay time. Although described having reference to vehicles and vehicle positioning, it will be appreciated that the invention may be applied to other assets and objects.

What is claimed is:

1. A method of administering a road use credit system by an administrator, the method comprising:
a. enrolling a plurality of motorists in the road use credit system, and establishing an account for each motorist with a pre-allocated number of road use credits;
b. receiving data of the road use of each motorist and deducting a pre-determined amount of road use credits from the motorist's account based on the motorist's road use data;
c. providing an interface by which the motorists can purchase additional road use credits, and adding the additional road use credits to a motorist's account when purchased;
d. providing an interface by which the motorists can communicate with other motorists to negotiate purchase, sale and transfer transactions of their road use credits, and adjusting the balance of road use credits in each of the motorists' accounts at the completion of each said transaction.

2. The method of claim 1, wherein the credits are serialized for enabling auditing the transactions and deductions for road use.

3. The method of claim 1, wherein the road use data is gathered from satellite-tracked on-board units located in vehicles used by the motorists, which data is determined as the cars travel in a monitored area.

4. The method of claim 1, wherein the road use credits are deducted based on a distance traveled in the monitored area.

5. The method of claim 1, wherein the road use credits are deducted based on a distance traveled in the monitored area, according to the time of day.

6. The method of claim 1, wherein the road use credits are deducted based on a time spent travelling in the monitored area.

7. The method of claim 1, wherein the road use credits are notionally tracked as distance units.

8. The method of claim 1, wherein the road use credits are notionally tracked as units of a currency.

9. The method of claim 1, wherein additional road use credits are granted to at least one motorist by the administrator based on a criteria, or as part of a lottery.

10. The method of claim 1, wherein the price of road use credits is fixed.

11. The method of claim 1, wherein the price of road use credits is negotiable.

12. The method of claim 1, wherein the interface is an internet-based interface.

13. The method of claim 1, wherein the road use credits are deducted based on path of travel on a chargeable road.

14. The method of claim 1, wherein the road use credits are deducted at a pre-selected rate of deduction which is a function of the traffic congestion on the chargeable road.

15. A method of enabling a transaction in road use credits between a first motorist and a second motorist, the method comprising:
a. receiving an offer proposal from a first motorist having a number of road use credits;
b. receiving a purchase proposal from a second motorist wishing to acquire the number of road use credits held by the first motorist;
c. verifying a payment received by the first motorist from the second motorist for the road use credits, or an authorization by the first motorist permitting a transfer of the road use credits without payment; and
d. contingent on step (c), deducting the number of road use credits from an account of the first motorist, and adding the number of road use credits to an account of the second motorist.

16. The method of claim 15, wherein step (b) comprises receiving purchase proposals from a plurality of second motorists in an auction, wherein only one proposal is selected by the first motorist.

17. The method of claim 15, wherein the credits are serialized for enabling auditing the transactions.

18. The method of claim 15, further comprising verifying the account status of at least one of the first motorist and the second motorist and refusing the transaction if either of the accounts is suspended.

19. The method of claim 15, wherein the first motorist and the second motorist are anonymous or pseudonymous to each other during the transaction.

20. A method of enabling exchange transactions in road use credits among a plurality of motorists having accounts of road use credits, the method comprising:
providing a commodities exchange for the motorists to trade road use credits between and among themselves, such that a first subset of motorists have credits debited from their accounts in exchange for payments issued by the exchange, and a second subset of motorists have credits credited to their accounts in exchange for payments paid to the exchange by the second subset of motorists.

21. The method of claim 20, further comprising the step of establishing via the exchange the fair market value of the credits as determined by the market forces of supply and demand.
